(19) United States
(12) Patent Application Publication
(10) Pub. No.: US 2020/0148553 A1
(43) Pub. Date: May 14, 2020

(54) Liquid Preparation Device

(71) Applicant: Electrophor Inc., Woodmere, NY (US)

(72) Inventors: Joseph Lvovich Shmidt, Woodmere, NY (US); Alexander Alexandrovich Cherny, St. Petersburg (RU)

(21) Appl. No.: 16/185,907

(22) Filed: Nov. 9, 2018

(51) Int. Cl. C02F 1/02; F25B 21/04; C02F 1/44; A23L 2/54; C02F 1/68

(52) U.S. Cl. CPC C02F 1/02; F25B 21/04; C02F 1/44; A23V 2002/00; C02F 1/68; C02F 2209/42; A23L 2/54

(57) ABSTRACT

A liquid preparation device intended for simultaneous heating and cooling of a liquid, said device including a raw liquid container, a thermoelectric converter, a control unit, a flow separation unit and a liquid preparation container being divided into a liquid heating section and a liquid cooling section, each section having a respective impermeable barrier adjacent to said thermoelectric converter. A liquid level control device is provided on the outer side of upper walls of the liquid heating section and of the liquid cooling section and in the form of a tray having a liquid level sensor on the bottom. An air exhaust is formed by two openings disposed symmetrically above the heating and cooling sections. A control unit contains a controller and, connected to it, said liquid level control device, disposed in the liquid preparation container.

### TECHNICAL FIELD

This specification relates to portable devices for preparation of a liquid, mostly water from household and/or drinking water supply sources, in particular for heating and cooling or heating, cooling and purification of a liquid to be used in household, summer cottages and garden plots or public catering.

### BACKGROUND

Conventional liquid preparation devices may be used to heat or cool a liquid, and to heat and cool a liquid. The liquid preparation systems may further have the function of liquid purification and/or making beverages.

A liquid preparation device for simultaneous heating and cooling of a liquid is disclosed in U.S. patent application No. 2009/0113898 [IPC F25B21/02, published Jul. 5, 2009]. The liquid preparation device comprises two liquid preparation containers: a liquid heating container and a liquid cooling container, and a thermoelectric converter with a heating and cooling surface disposed between the two containers. The containers are each in the form of a closed insulated tank, into which a bottle with a raw liquid is inserted. The liquid heating container is disposed above the liquid cooling container.

The thermoelectric converter is part of the liquid heating and cooling means, which is a composite structure and, in addition to the thermoelectric converter, comprises a heater and a condenser, the heater being connected to the heating surface of the thermoelectric converter, and the condenser being connected to the cooling surface of the thermoelectric converter. A coolant is provided inside the condenser and heater. The liquid cooling container is connected via a tube to the condenser. The liquid heating container is connected via a tube to the heater. Downstream of the heater and upstream of the liquid heating container, an additional condenser is connected to a tube for additional condensation of the coolant. The device further comprises a fan to cool the additional condenser.

The liquid preparation device operates as follows.

Bottles with raw liquid are installed in the liquid heating and cooling containers. During operation of the thermoelectric converter, heat is transferred from the heating surface to the heater with the coolant, the latter is heated and converted to vapor. The vapor enters the liquid heating container via the tube connected to the heated liquid section; heat is transferred from the vaporized coolant to the container walls, and then through the bottle walls to the liquid thereby heating the same, while the coolant condenses into liquid and returns back through the additional condenser to the heater via the same tube, through which the vapor passes. At the same time, process of cooling the liquid occurs. The coolant is cooled in the condenser by operating the thermoelectric converter. The coolant enters the liquid cooling container; heat is transferred from the liquid to the coolant through the bottle walls and therefore the liquid is cooled. Furthermore, the coolant is heated, gets vaporized and returns to the condenser through the tube. Upon reaching a specified temperature, at least one of the bottles is removed by the consumer from the heated and cooled liquid containers.

It is apparent from the foregoing that the energy transfer means through which liquid is heated and cooled is the coolant. For this reason, energy transfer (process of heating and cooling) in the device occurs in two stages. First stage involves heating and cooling the coolant, and the second stage involves heating and cooling the liquid in the heated and cooled liquid sections through the contact between the coolant and walls of the bottles.

The energy transfer is the main drawback of the device according to US 2009/0113898, since the coolant must be heated to a temperature above the required liquid temperature. This is necessary to reduce energy loss of the coolant as it moves through tubes, which results in inefficient use of energy generated by the thermoelectric converter.

Furthermore, when vaporized coolant collides with liquid coolant in the tubes connected to the heater and the condenser, a heat exchange occurs there and temperature of coolant decreases (in the tube connected to the heater) or rises (in the tube connected to the condenser), which causes loss of energy for heating or cooling.

Furthermore, the device according to US 2009/0113898 uses freon R134a as a coolant, which is undesirable as this substance is hazardous to human health and causes damage to the ozone layer.

Another liquid preparation device is disclosed in U.S patent application no. 2010/0018220 [IPC G01G23/18, F25B21/02, G05B15/00, published Feb. 28, 2010]. The device is intended for heating or cooling a liquid, according to the consumer's needs.

The device according to US 2010/0018220 comprises a container and a thermoelectric converter having a liquid heating surface and a liquid cooling surface. The container has a raw liquid supply opening, into which a thin tube is placed to withdraw heated or cooled liquid for consumption. A heat transfer plate connected to the thermoelectric converter adjoins the container. The device according to US 2010/0018220 comprises a fan to cool the adjacent surface of the thermoelectric converter. According to US 2010/0018220, a control module controls the operation of the device. The control module comprises a controller connected to a display panel and two mode switches (heating or cooling) provided thereon, and time and temperature indicators. All parts and components of the device are enclosed in a housing with a door, which is also the front wall of the housing.

The device according to US 2010/0018220 operates as follows. Raw liquid is poured into a container intended for heating or cooling through a raw liquid opening. Control unit switches polarities in the thermoelectric converter and thereby changes heating or cooling modes. Using the control unit, the consumer switches the device operation mode to heat or cool the liquid as needed. The liquid is heated or cooled. The display panel shows when the process of heating or cooling the liquid is complete. Then, the consumer gets prepared liquid through the withdrawal tube.

The device according to US 2010/0018220 has several disadvantages.

As stated above, the device is intended for heating and/or cooling a liquid, however, depending on the consumer's needs, only a single process (heating or cooling) can be performed at a time during the operation of the device and it is impossible to get heated and cooled liquid simultaneously. When liquid is cooled, the heating surface of the thermoelectric converter will be idle due to the polarity change. To reduce temperature of the heating surface, a fan is used. Therefore, when liquid is cooled, energy generated by the heating surface of the thermoelectric converter is used inefficiently. The use of a fan also increases energy consumption in operation of the device according to US 2010/0018220.

A liquid preparation device is disclosed in U.S. Pat. No. 4,833,888 [IPC F25B21/02, published May 30,1986]. A liquid preparation device according to U.S. Pat. No. 4,833,888 comprises a housing with a container accommodated therein, a thermoelectric converter, a heat transfer means and a reverse osmosis liquid purification module. The container is used to heat or cool a liquid. The heat transfer means is mounted on an outer wall of the container. A control unit is further mounted on the outer wall of the container to switch modes of heating or cooling. The device further comprises a raw liquid feed line connected to an inlet of the reverse osmosis liquid purification module. Purified liquid outlet of the reverse osmosis liquid purification module is connected, through the purified liquid supply line, to the container; drain liquid outlet of the reverse osmosis liquid purification module is connected to the heat transfer means. The heat transfer means is a composite structure comprised of a flow distributor, a copper plate, a first heat-conducting film, a thermoelectric converter and a second heat-conducting film. The flow distributor is a heat exchanger with a passage inside to pass drain liquid. The device further comprises a control panel connected with the thermoelectric converter and the flow distributor. The control unit switches polarities according to the consumer's needs and drain liquid, passing through a channel in the flow distributor, either takes heat from the container or gives heat to the container. A waste drain liquid discharge line is connected to an outlet of the heat transfer means. A consumer hot or cooled purified liquid supply line with a circulation pump mounted thereon is connected to a hot or cooled purified liquid outlet of the container.

The device according to U.S. Pat. No. 4,833,888 operates as follows.

Raw liquid enters the reverse osmosis liquid purification module through a raw liquid feed line. Purified liquid enters the liquid preparation container through the purified liquid supply line. Drain liquid flows from the liquid purification means through the drain liquid supply line to inlet of the heat transfer means. While passing through the flow distributor, drain liquid either takes heat from the container (cooling mode) or gives heat to the container (heating mode) depending on the operation mode of the device. Prepared purified liquid enters then the purified liquid supply line. Waste drain liquid flows from the heat transfer means to a drainage disposal line. Drain liquid enters the drainage disposal line in heated state, which is undesirable since the increased temperature contributes to the development of bacteria in the drain liquid.

The main drawback of the device according to U.S. Pat. No. 4,833,888 is the use of drain liquid as the coolant. Since the diameter of the flow distributor channel is relatively small, the flow distributor and the lines leading to the heat transfer medium will become clogged with time and, therefore, the liquid passage channels will be blocked, causing thereby disturbance of heat transfer and failure of the device.

U.S. Pat. No. 2,910,836 [IPC F25B21/02, F25B29/00, H01L35/00, publ. Mar. 11,1959] discloses a liquid preparation device for simultaneous heating and cooling of a liquid.

The liquid preparation device according to U.S. Pat. No. 2,910,836 comprises a housing with a liquid preparation container disposed therein and divided into a liquid heating section having a consumer heated liquid outlet means, a liquid cooling section having at least one raw liquid inlet and a consumer cooled liquid outlet means, and a thermoelectric converter having a heating surface and a cooling surface disposed between the heated and cooled liquid sections. A temperature sensor is disposed in the heated liquid section and connected to a power supply that is also connected to the thermoelectric converter. The liquid heating section is arranged exactly above the liquid cooling section. The consumer hot liquid outlet means is disposed in the upper part of the hot liquid section. The consumer cooled liquid outlet means is disposed in the lower part of the cooled liquid section.

The liquid preparation container has got the shape of a parallelepiped. The thermoelectric converter divides the internal space of the liquid preparation container into a liquid heating section and a liquid cooling section of the same volume. The thermoelectric converter comprises paired electrodes between which through channels are provided for liquid flow.

The device according to U.S. Pat. No. 2,910,836 operates as follows.

Raw liquid enters the liquid cooling section through a raw liquid inlet and, passing through the through channels in the thermoelectric converter, gradually fills the entire internal space of the container. Operation of the thermoelectric converter provides heating and cooling the liquid at the same time. Furthermore, liquid is redistributed and partially mixed through the through channels. Heated liquid moves upwards to the liquid heating section and cooled liquid moves downwards to the liquid cooling section. As need arises, the prepared liquid is supplied to the consumer through hot and cooled liquid supply means. If the temperature in the hot liquid section exceeds a preset value, the temperature sensor is actuated and the thermoelectric converter gets disconnected from the power supply.

The main drawback of the liquid preparation device according to U.S. Pat. No. 2,910,836 is the mass transfer of heated and cooled liquid through the through channels in the thermoelectric converter. Thus, liquid with maximum temperature accumulates in the uppermost layer of the liquid heating section, and liquid with minimum temperature accumulates in the lower layer of the liquid cooling section. Therefore, the heated liquid outlet means should be disposed in the upper part of the liquid heating section, while the cooled liquid outlet means should be disposed in the lower part of the liquid cooling section. As the heated liquid layer locates only in the upper part of the liquid heating section, and the cooled liquid layer is in the lower part of the cooling section, consumers will be able to withdraw only a small amount of liquid. Therefore, both sections have a small effective capacity.

SU Pat. No. 1,764,094 [IPC H01L35/02, F25B21/02, published Jan 19,1993] discloses a device for simultaneous heating and cooling of liquids. The device comprises a raw liquid container, a thermoelectric converter, a control unit and a liquid preparation container divided into a liquid heating section and a liquid cooling section. Each section has got a respective impermeable barrier arranged adjacent to said thermoelectric converter. The liquid cooling section is equipped with a temperature sensor connected with the electromagnetic valve and the power supply. The liquid cooling section is separated from the raw liquid container by a partition in which two openings—an input and an output are executed. The input opening is blocked by the electromagnetic valve. The liquid heating section is isolated from both the liquid cooling section and the raw liquid container; the liquid heating section has a separate input for raw liquid and output for prepared liquid.

The device according to SU Pat. No. 1,764,094 operates as follows. The raw liquid is filled into the raw liquid container and into the liquid heating section. And raw liquid container has to be filled in plenty to fill the liquid cooling section. When the raw liquid container and said sections are filled, the liquid preparation process starts. In case the temperature in liquid cooling section falls below a set value, the electromagnetic valve opens an input opening for raw liquid. There is mass and heat transfer between cooled liquid in liquid cooling section and raw liquid in raw liquid section. The temperature in the liquid cooling section increases. When consumer takes some liquid from the liquid cooling section, the raw liquid container is the source of that volume of liquid which was taken.

The device according to SU Pat. No. 1,764,094 has a number of drawbacks. For example, implementation of heat and mass transfer between the liquid cooling section and the raw liquid container, when liquid hypercooling in the liquid cooling section takes place, and when liquid is taken by the consumer. If mixing warm raw liquid with cooled liquid when thermoelectric converter is working takes place, it is necessary that the temperature of the liquid is leveled in the entire volume of the liquid cooling section which requires time. Furthermore, the device according to SU Pat. No. 1,764,094 has got no means to interfere hypercooling of liquid in the liquid cooling section. In the first and second cases the thermoelectric converter almost idles which leads to excess expenses of energy. Also raw liquid supply from the raw liquid container to the liquid cooling section is nonregenerable. Liquid drifts to section during its withdrawal. The liquid heating section is completely isolated from the raw liquid container. A liquid supply to it depends completely on an external source of liquid to which the container is connected, or the consumer has to watch/check liquid level in it.

### SUMMARY

The object of the present invention is to provide a new compact liquid preparation device and increase the efficiency of using the heat generated by the device to heat the liquid, while reducing the energy consumption.

The liquid preparation device of the present invention, intended for simultaneous heating and cooling of a liquid, comprises a raw liquid container, a thermoelectric converter, a control unit, a flow separation unit and a liquid preparation container being divided into a liquid heating section and a liquid cooling section, each section having an upper wall and a respective impermeable barrier adjacent to said thermoelectric converter, a liquid level control means provided on an outer side of said upper walls of the liquid heating section and of the liquid cooling section, said liquid level control means being formed as a tray with a liquid level sensor on a bottom thereof, and an air exhaust means formed by two openings disposed symmetrically above said sections, and a control unit containing a controller and, connected to it, said liquid level control means, disposed in a liquid preparation container, and the liquid level sensor disposed in the raw liquid container, and a pressurized fluid supply line connected to a pressurizing unit. Here, the pressurizing means comprises, preferably e.g. a compressor or centrifugal pump. Also the device is additionally provided with a liquid purification means and a raw liquid feed line, wherein an inlet of the said liquid purification means is connected to the raw liquid feed line and an outlet is connected to the flow separation unit via the raw liquid supply line. Also the device is additionally provided with a flow heater which is made as a spiral heater and connected to the liquid heating section. Also the device is additionally provided with a cooled liquid carbonation means connected to the liquid cooling section. Furthermore, said device also comprises a secondary pressurizing unit switched to the control unit and connected to the flow distribution unit.

### DETAILED DESCRIPTION

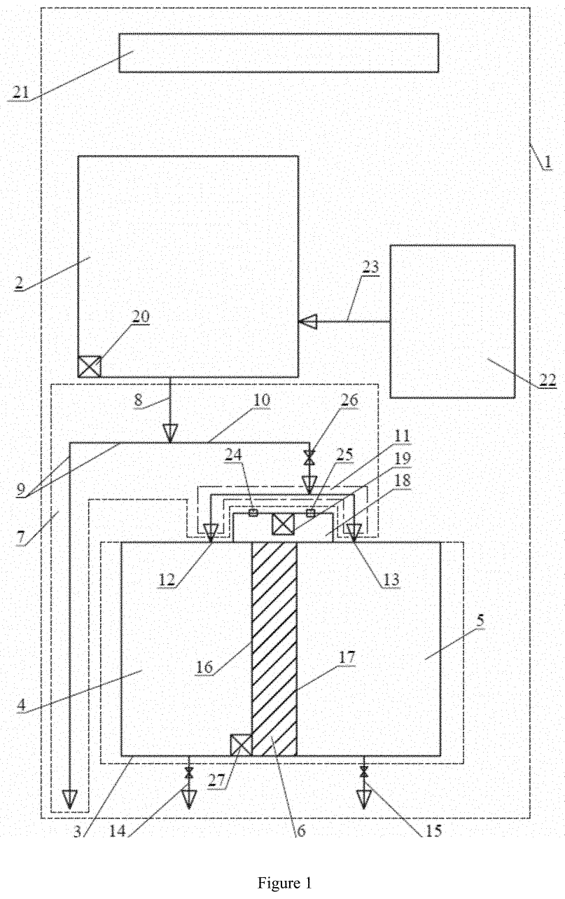

FIG. 1 shows a schematic diagram of a liquid preparation device.

Referring to the schematic diagram shown in FIG. 1, a liquid preparation device comprises a housing (1) accommodating a liquid preparation container (2) divided into a liquid heating section (3) having a raw liquid inlet (8) and a consumer heated liquid outlet means (11) and a liquid cooling section (4) having a raw liquid inlet (9) and a consumer cooled liquid outlet (12), and a thermoelectric converter (5) having a heating surface (6) and a cooling surface (7). The liquid heating section (3) and the liquid cooling section (4) are provided with impermeable barriers (10) and (13), respectively, adjacent to the thermoelectric converter (5). The liquid heating section (3) has a volume smaller than that of the liquid cooling section (4). The ratio of the volumes is not less than 1 to 2 and not more than 1 to 10, preferably 1 to 3.

The thermoelectric converter (5) is disposed between the liquid heating section (3) and the liquid cooling section (4). The heating surface (6) is adjacent to the impermeable barrier (10) of the liquid heating section (3), and the cooling surface (7) is adjacent to the impenetrable partition (13) of the liquid cooling section (4) (FIG. 1).

The device may further comprise a flow separation unit (not shown), which contains a consumer liquid supply line and a liquid supply line to the liquid preparation container (2). The liquid supply line to the liquid preparation container (2) is provided with a flow separation means, for example, a tee, connected to raw liquid inlet (8) to the heated liquid section (3) and to raw liquid inlet (9) to the cooled liquid section (4).

The device may further comprise a raw liquid container (not shown).

Furthermore, the device may comprise a pressurizing unit containing a pressurizing means and a pressurized fluid supply line connected to it (not shown). The pressurized fluid supply line is connected to the raw liquid container (not shown). The pressurizing means can be, for example, but not limited to, a compressor or a centrifugal pump (not shown). Where the pressurizing means is a compressor, the pressurized fluid supply line is intended to supply pressurized gas, for example, air (not shown). Where the pressurizing means is a centrifugal pump, the pressurized fluid supply line is intended to supply raw liquid (not shown) from the raw liquid container to the liquid purification unit.

The liquid preparation device may further comprise a liquid purification unit containing a liquid purification means and a purified raw liquid supply line connected to it. The purified raw liquid supply line is connected to a flow separation unit (not shown).

The liquid purification means can be, for example, but not limited to, in the form of a housing including a filtering mixture layer and a hollow-fiber module, or a housing filled with a filtering mixture (not shown).

Where the liquid purification means is in the form of a housing including a filtering mixture layer and a hollow-fiber module, the pressurizing means is a compressor that is required to displace raw liquid from the raw liquid container through the liquid purification means of the liquid purification unit into the liquid preparation container (2) (not shown).

Where the liquid purification means is in the form of a housing filled with a filtering mixture, the pressurizing means can be a centrifugal pump that is required for pumping raw liquid into the liquid preparation container (2) (not shown).

The raw liquid feed line is connected to the raw liquid container and to inlet of the liquid purification means of the liquid purification unit (not shown).

A liquid level control means may be further provided on the outer side of upper walls of the two sections (3) and (4) in the form of a tray having a liquid level sensor on the bottom and an air exhaust means formed by two openings disposed symmetrically above the liquid heating section (3) and above the liquid cooling section (4) (not shown). A flow heater (not shown) is connected to outlet of the liquid heating section (3). Outlet of the flow heater is connected to a consumer heated liquid outlet means (11). A cooled liquid carbonation means (not shown) is connected to outlet of the liquid cooling section (4), and outlet of the cooled liquid carbonation means is connected to the consumer cooled liquid outlet means (12). A valve is mounted in the heated liquid outlet means (11). The cooled liquid outlet means (12) comprises a valve (not shown).

Furthermore, the preparation device may comprise a control unit containing a controller and, connected to it, a liquid level control means and a liquid level sensor disposed in the raw liquid container (not shown).

The liquid preparation device can further comprise a display panel (not shown) comprising a plurality of LEDs mounted in the control unit and visible to the consumer, which identify heating and cooling processes, readiness to supply cooled liquid, presence of liquid in the raw liquid container, service life of the module. The display panel further comprises a heated liquid (65° C.) button, a hot liquid (100° C.) button, a cooled liquid button and a carbonated liquid button.

Furthermore, the liquid preparation device may comprise a secondary pressurizing unit (not shown), which contains an auxiliary pressurizing means such as a low-power compressor and an auxiliary pressurized fluid (in this case gas e.g. air) supply line connected to the liquid supply line of a liquid distribution unit (13). The secondary pressurizing unit is needed to supply liquid to the consumer.

Within the scope of the distinctive features, the liquid preparation device operates as follows.

Raw liquid enters simultaneously the liquid heating section (3) through the raw liquid inlet (8) of the liquid heating section (3) and the liquid cooling section (4) through the raw liquid inlet (9) of the liquid cooling section (4). Heating and cooling the liquid takes place owing to the thermoelectric converter (5). According to the present invention, the energy released when the liquid is cooled is transferred from the heating surface (6) of the thermoelectric converter to the adjacent impermeable barrier (10) of the liquid heating section (3). In contrast to the closest prior art, the liquid preparation container (2) is formed such no mass transfer of liquid occurs between the two sections in the process of heating and cooling the liquid. Upon completion of the heating and cooling processes, the device is ready to supply the prepared liquid to the consumer: heated liquid through the heated liquid supply means (11) and cooled liquid through the cooled liquid supply means (12).

In the case where the liquid preparation device further comprises a raw liquid container, the liquid level sensor disposed therein (not shown) activates when the container is filled. The control unit receives signal from the liquid level sensor. At this instant, the pressurizing means, for example, a compressor (not shown), is actuated. Pressurized gas, for example, air, starts flowing through the pressurized fluid supply line into the raw liquid container and displaces the raw liquid through the raw liquid feed line to the liquid purification means of the liquid purification unit. From the liquid purification means, the purified raw liquid enters the flow separation unit. Depending on the consumer needs, the liquid flows from the flow separation unit either through the consumer liquid supply line for consumption, or through the liquid supply line to the liquid preparation container (2) to the liquid preparation container (2). Through the liquid supply line to the liquid preparation container (2) via the flow separation means the liquid enters simultaneously the heated liquid section (3) and the cooled liquid section (4). Upon filling the sections (3) and (4) the liquid level sensor of the liquid level control device operates the control unit receives its signal and deactivates the pressurizing means. The liquid is heated and cooled in sections (3) and (4) by means of the thermoelectric converter (5). During heating and cooling the liquid, LEDs responsible for indication of these processes blink on the display panel. After completion of the heating and cooling processes, the LEDs go to constantly lighted mode.

When the consumer presses the heated liquid button, a valve in the heated liquid outlet means (10) opens and heated liquid is fed to the consumer through the flow heater (not shown) and the heated liquid outlet means (11). Therewith, the flow heater is turned off. When the consumer presses the hot liquid button, the flow heater turns on and the second heating stage is performed.

When the consumer presses the cooled liquid button, a valve opens in the consumer cooled liquid outlet means (11) and cooled liquid is fed to the consumer through the cooled liquid outlet means (11). When the consumer presses the carbonated liquid button, purified cooled liquid enters the liquid carbonation means (not shown), and then, with the valve open, flows through the consumer cooled liquid outlet means (11).

As is known in the prior art, at cooled liquid intake from liquid cooling section there is a dilution of the cooled liquid with warmer raw liquid and temperature increase of liquid cooling section. Alignment of temperature in volume of section requires time and additional expenses of energy which is spent for operation of the thermoelectric converter. The same occurs also at high cooling of liquid in liquid cooling section. Besides, in the device of the closest analog there is no means for liquid heating section overheating prevention. Because of it, temperature of heated liquid can reach boiling temperature, and liquid can gradually evaporate. In the absence of liquid in liquid heating section there will be an overheating of heating surface of the thermoelectric converter and its failure. Also the liquid heating section is completely isolated from raw liquid container. Liquid supply depends completely on an external source to which it is connected or as it was already told earlier, the consumer has to watch liquid level in it.

In the device according to the invention, the above drawback is eliminated through a design of the liquid preparation container and the flow separation unit.

As it has been stated above in the description of SU Pat. No. 1,764,094, during cooled liquid consumption by the consumer raw liquid from raw liquid container begins to flow to liquid cooling section. There is a mixture of the raw and cooled liquids that increases the temperature in the liquid cooling section and requires additional operation of the thermoelectric converter. In the present invention, the need of supply of raw liquid in sections (3) and (4) is eliminated during prepared liquid consumption by the consumer. Adjustable supply of raw liquid in sections (3) and (4) is carried out right after the termination of the prepared liquid consumption by the consumer that reduces waiting time to receive the prepared liquid and reduces energy consumption on heating and cooling of liquid.

The above description discloses a preferred embodiment of the invention. Changes can be made to the embodiment of the invention as described above without departing from the scope of the claims, thereby allowing for its wide usage.

1. A liquid preparation device for simultaneous heating and cooling of a liquid, said device comprising:
a raw liquid container,
a thermoelectric converter,
a control unit,
a flow separation unit, and
a liquid preparation container being divided into a liquid heating section and a liquid cooling section, each section having an upper wall and a respective impermeable barrier adjacent to said thermoelectric converter, and
a liquid level control means provided on an outer side of said upper walls of the liquid heating section and of the liquid cooling section, said liquid level control means being formed as a tray with a liquid level sensor on a bottom thereof, and
an air exhaust means formed by two openings disposed symmetrically above the liquid heating section and the liquid cooling section, and
a control unit containing a controller and said liquid level control means connected to the controller and disposed in said liquid preparation container, and
said liquid level sensor disposed in said raw liquid container, and
a pressurized fluid supply line connected to a pressurizing unit.

2. The device according to claim 1, wherein the pressurizing means comprises one of a compressor or a centrifugal pump.

3. The device according to claim 1, further comprising a liquid purification means with an inlet and an outlet, and a raw liquid feed line, the inlet of said liquid purification means being connected to the raw liquid feed line, and the outlet being connected to the flow separation unit via the raw liquid supply line.

4. The device according to claim 1, further comprising a flow heater connected to the liquid heating section.

5. The device according to claim 1, further comprising a cooled liquid carbonation means connected to the liquid cooling section.

6. The device according to claim 1, further comprising a secondary pressurizing unit switched to the control unit and connected to the flow distribution unit.
